(19) United States
(12) Patent Application Publication
(10) Pub. No.: US 2025/0314793 A1
(43) Pub. Date: Oct. 9, 2025

(54) SEMq System for Identification, Determination, Characterization, and/or Quantification of Groundwater or Aquifers

(71) Applicant: G-Strata SpA, City of Concepcion (CL)

(72) Inventor: Jorge JIMENEZ, City of Concepcion (CL)

(21) Appl. No.: 19/047,044

(22) Filed: Feb. 6, 2025

(30) Foreign Application Priority Data
Apr. 4, 2024 (CL) 202401192

(51) Int. Cl. G01V 1/38

(52) U.S. Cl. CPC G01V 1/3808; G01V 1/3835

(57) ABSTRACT

A system and process are provided for identification, determination, characterization, and/or quantification of groundwater. According to an embodiment, the system includes an information input unit, an information packaging and process unit, and an information output unit. The information input unit includes sensors, modules, and microcontrollers configured for data acquisition relating to the groundwater. The information packaging and processing unit is configured to utilize software, AI, Blockchain, and/or Smart Contracts. The information output unit is configured to output information through applications, web platforms, reports, and/or alerts.

### CLAIM OF PRIORITY AND CROSS-REFERENCED TO RELATED FOREIGN APPLICATION

This application claims the benefit of priority of Chilean patent application No. 202401192 filed Apr. 4, 2024, the complete disclosure of which is incorporated herein by reference.

### FIELD

Aspects of the present disclosure relate to implementation in the field of hydrogeology or subsurface hydrology, particularly for the identification, determination, characterization, and/or quantification of groundwater or aquifers, to provide new sources of water for uses such as agriculture, industry, and/or human consumption. Additionally, aspects of the present disclosure relate to tools for the management of underground resources. In some implementations, the present disclosure relates to a geophysical system called SEMq, which utilizes a SER (SeismoElectric and Resistivity) methodology to identify, determine, characterize, and/or quantify groundwater without the need for drilling and with high precision.

### BACKGROUND

The problem of water scarcity worldwide is a critical threat to humanity. As populations increase and natural resources reduce, there is an alarming rise in the number of people lacking access to the water necessary to sustain a healthy life. In this context, it is vital to develop technology for water identification, enabling the fulfillment of resource needs. Particularly, it is necessary to provide alternatives for exploiting existing underground water resources to support human activities such as agriculture, industry, and supplying communities in need of quality water.

Bodies of water are stretches of water found on the earth's surface or underground, either in liquid or solid states, and can be either saltwater or freshwater.

Some examples of bodies of water include:
Rivers: Streams of water that flow into the sea or other rivers.
Lakes: Depressions in the land occupied by water.
Lagoons: Bodies of water adjacent to the ocean, typically isolated marine waters.
Oceans: Saltwater masses covering most of the Earth's surface.
Seas: Smaller saltwater masses compared to oceans.
Estuaries: Brackish water bodies where freshwater from rivers mixes with seawater.
Aquifers: Porous geological formations containing groundwater.

Water bodies are significant as they provide freshwater for human consumption, agriculture, and industry, and water bodies serve as habitats for diverse animal and plant species.

Groundwater refers to water found beneath the earth's surface, occupying the porous spaces in soil, sand, and rock. These waters move through geological formations called aquifers, which can store and transmit significant amounts of water.

Aquifers exist at various depths and can significantly vary in their capacity to store and transmit water. Groundwater characteristics, such as quality and quantity, depend on factors such as local geology, precipitation, interactions with surface water bodies, and human extraction.

Groundwater is a crucial source of freshwater used for various purposes, including potable water supply, agricultural irrigation, and as a resource in industry. Groundwater exploitation must be sustainable to prevent overexploitation, which can lead to aquifer degradation, declining water levels, and contamination.

Globally, groundwater accounts for approximately 30% of available liquid freshwater. According to the United Nations Food and Agriculture Organization (FAO), over 40% of the water used for irrigation comes from underground sources. However, in many regions, overexploitation has led to alarming declines in groundwater levels.

The identification, determination, characterization, and/or quantification of groundwater are essential for its sustainable management and mitigating water scarcity. In this context, in some embodiments, the present technology proposes a geophysical instrument capable of measuring electrical and magnetic signals related to the seismo-electromagnetic effect, significantly transforming how subsurface water resources are explored and managed. By providing a precise tool to locate and quantify groundwater, some embodiments of this technology can improve the efficiency of aquifer exploitation, ensure sustainable use, and help prevent overexploitation and contamination.

Some references and statistics on the aforementioned aspects can be gathered from the following sources:
United Nations Food and Agriculture Organization (FAO).
UNESCO's World Water Assessment Programme.
Reports by the Intergovernmental Panel on Climate Change (IPCC).
Scientific publications and journals specializing in hydrology and water resources.
World Bank (IBRD-IDA).

These sources provide updated statistical information, case studies, and analyses on global groundwater management.

Techniques for detecting, identifying, characterizing, and/or quantifying groundwater have significantly evolved over the years, from traditional methods based on direct observations and exploratory drilling to advanced technologies utilizing geophysical, chemical, and biological principles.

Identifying groundwater can be a complex process as groundwater is underground and not visible to the naked eye. Groundwater often resides in aquifers, which are permeable rocks and/or sediments that contain water. Traditional methods for identifying groundwater include:
Exploratory drilling: A direct but costly method limited to specific points.
Hydrogeological studies: Based on geological maps and the observation of springs and watercourses, offering a general but less detailed view.

Advanced technology, specifically geophysical exploration methods or prospecting methods, are techniques that allow the analysis of the subsurface's physical properties for various applications, such as locating groundwater, delineating contaminated soils, and evaluating soil quality for construction.

Geophysical methods are based on studying the Earth's physical properties, such as gravity, magnetism, electricity, nuclear properties, heat, or seismic waves. These methods can generally be categorized into two major groups:

The first group of methods are passive methods, which utilize natural energy sources such as Earth's gravitational or magnetic field or seismic waves generated by earthquakes or volcanoes.

The second group of methods are active methods, which require an artificial energy source, such as an explosive, a hammer, an electric current, or a radio antenna.

Each geophysical method has its advantages and limitations and is applied depending on the study's objective and scale.

The most commonly used geophysical methods for groundwater exploration are as follows:
1. In electrical methods, electrical geophysics identifies subsurface layers and bodies by measuring substrate electrical resistivity. These are among the most employed techniques for groundwater exploration. This is achieved by injecting a known electric current and measuring the subsurface response to this stimulus. Resistivity refers to a material's ability to resist the flow of electric current. Common electrical geophysics methods include Vertical Electrical Sounding (VES) and Electrical Resistivity Tomography (ERT).
2. In seismic methods, seismic geophysics relies on measuring pressure waves to detect groundwater. Widely used in the oil industry, common seismic geophysics methods include Seismic Reflection, Seismic Refraction, and Seismoelectric methods. The latter combines a seismic method with an electrical response associated with the presence of groundwater.
3. In electromagnetic methods, electromagnetic geophysics measures variations in electrical resistivity using electromagnetic fields (EM), which can be natural or artificial. Notable electromagnetic geophysics methods include Transient Electromagnetic (TEM) or Magnetotelluric, and its variants, Audio-Magnetotelluric (AMT), or Controlled-Source Audio-Magnetotelluric (CSAMT).
4. In magnetic methods, magnetometric geophysics measure magnetic fields generated by currents produced by water passing through subsurface interstices. This method is less commonly used for groundwater exploration because these natural currents, often called spontaneous potentials, are weak.
5. In gravimetric methods, gravimetric geophysics measures gravitational anomalies to infer potential groundwater locations indirectly. This method is used for water exploration through geological characterization of an area.
6. In nuclear methods, notably Proton Magnetic Resonance (PMR), a high-frequency electromagnetic pulse similar to the Larmor frequency of hydrogen protons is emitted, exciting the water's protons and measuring the relaxation time to equilibrium. This provides information about subsurface water up to several hundred meters deep.

To delve deeper into geophysical methods applied to groundwater exploration, general references and titles widely recognized in hydrogeology and geophysics are recommended. These sources include books, scientific articles, and educational resources covering basic principles and advanced applications of geophysical methods in groundwater exploration.

### Books and Texts

Applied Hydrogeophysics (NATO Science Series: IV: Earth and Environmental Sciences), edited by H. Vereecken, A. Binley, G. Cassiani, A. Revil, and K. Titov. This book addresses various geophysical techniques applied in hydrogeology, including electrical resistivity, ground-penetrating radar, and electromagnetic methods.
Groundwater Geophysics: A Tool for Hydrogeology, edited by Reinhard Kirsch. This text provides a comprehensive view of geophysical methods used in groundwater exploration, evaluating their practical and theoretical applications, advantages, and limitations.
Hydrogeophysics (Water Science and Technology Library), edited by Yoram Rubin and Susan S. Hubbard. This book introduces geophysical methods' applications in hydrogeology, presenting case studies and fundamental theories.
The Seismoelectric Method: Theory and Applications. The first edition was published in 2015 by John Wiley & Sons, Ltd.

### Scientific Articles and Publications

Journals such as Journal of Hydrology, Water Resources Research, and Geophysics publish research related to hydrogeology and applied geophysics. Look for articles focusing on groundwater exploration for recent case studies and technological developments.
“The use of electromagnetic methods in freshwater investigations” in the Journal of Applied Geophysics. Articles like this discuss using electromagnetic methods to detect and characterize groundwater bodies.

### Online Resources

USGS (United States Geological Survey): Provides resources and publications on applying geophysical methods in hydrological studies, including manuals and technical guides.
SEG (Society of Exploration Geophysicists): Offers a wide range of resources, including publications, courses, and conferences on applied geophysics.

A comprehensive review of other geophysical methods has not identified prior techniques that specifically integrate electrical and magnetic signal measurements of the seismo-electromagnetic effect for groundwater detection, suggesting innovation in the field.

Existing technologies may have limitations in detection depth, resolution, cost, and operational capability in diverse geological environments. The proposed new technology could address these limitations by offering deeper detections, higher precision, or lower cost. It is important to highlight specific areas of improvement and development for permitting optimization of the technology for groundwater identification.

As far as has been investigated, there is no system on the market that integrates all the features and advantages proposed by this disclosure, which validates its novelty and potential impact on groundwater exploration.

Currently, various geophysical systems for measuring electrical resistivity are among the most used for the hydrogeological characterization of an area. Among these systems, notable examples include the ABEM Terrameter LS2 from Guideline Geo and the POLARES32 system from PASI Geophysics, both corresponding to ERT systems. Additionally, the Sismoeléctrico GF-6 system from AquaLocate is also available on the market. When comparing these systems with the seismo-electromagnetic system (SEMq), the technological development proposed in the present disclosure, some distinctive differences are noteworthy in relation to some embodiments described herein:

Unique Capabilities: The ability of the seismo-electromagnetic system to integrate measurements of electrical and magnetic signals offers a unique advantage in detecting and characterizing groundwater, especially in complex geological environments where conventional techniques may have limitations.

Applicability in Different Geological Conditions: Depending on how the seismo-electromagnetic system handles geological variability, the system could outperform traditional resistivity and IP methods in areas with high salinity or particularly complex geological structures.

Data Integration and Analysis: The ability to combine and analyze data from different sources (electrical, magnetic, and seismic) provides a deeper understanding of the subsurface, enabling a more accurate interpretation of aquifer characteristics, such as their extent and permeability.

Regarding some patent documents related to the present disclosure, the following publications stand out: U.S. Pat. No. 8,633,700B1 by England et al., U.S. Pat. No. 7,340,348B2 by Strack and Allegar, and U.S. Pat. No. 7,330,790B2 by Berg Andrey. However, none of these documents develops or discloses technology comparable to the present disclosure.

### SUMMARY

This Summary is provided to introduce a selection of representative concepts in a simplified form, which representative concepts are further described below in the Detailed Description. This Summary is not intended to identify key features or essential features of the claimed subject matter, nor is it or the objects and benefits described herein intended to be used to limit the scope of the claimed subject matter.

Generally, some embodiments of the present disclosure relate to a geophysical system called SEMq, which utilizes the SER (SeismoElectric and Resistivity) methodology to identify, determine, characterize, and/or quantify groundwater without the need for drilling, and with a high level of precision.

In some embodiments, the present disclosure pertains to a system for identifying, determining, characterizing, and/or quantifying groundwater, comprising:

(i) An information input unit, including sensors, modules, and microcontrollers for data capture; (ii) A packaging and information processing unit using software, AI, Blockchain, or Smart Contracts; and (iii) An information output unit through apps, web platforms, reports, and/or alerts.

In some embodiments, the system is characterized by one or more of the following, alone or in any combination:
1. The information input unit (i) includes electrical sensors, such as electrodes; magnetic sensors, such as magnetometers; and seismic sensors, such as geophones.
2. The information input unit includes atmospheric modules and a global positioning system (GPS and/or GNSS) to obtain geographic coordinates of the prospecting site.
3. The system operates in a point-based mode, generating a specific survey or sounding for each measurement at the surveyed location.
4. The packaging and information processing unit (ii) comprises a microcontroller responsible for packaging the information from each sensor in the input unit.
5. The packaged information undergoes data processing through signal standardization software before being analyzed by specific software, AI, Blockchain, and/or Smart Contracts. This enables the generation of geophysical and hydrogeological models.
6. The information output unit (iii) includes reports and alerts via applications or web platforms. The output unit reports and alerts provide information on whether groundwater exists at the surveyed locations. In positive cases, for example, the reports and alerts indicate the depth of groundwater sources, such as aquifers and water tables, estimates the flow rate, and provides a stratigraphy of the surveyed area.
7. The collected information from the information output unit is fed into a predictive and hydrological analysis model, which can be used for hydrogeological and hydrological analysis and water security planning.

The innovation of the system of some embodiments of the present disclosure lies in its hardware, which integrates seismic, electrical, and magnetic signals from a controlled seismic event into a single package. In some embodiments, this package allows the visualization of the seismo-electromagnetic effect's behavior over a time series, known as the subsurface response to the acoustic stimulus generated at the surface. In some embodiments, the hardware addresses key challenges such as signal amplification and treatment to discern the relationship between signal and noise, a longstanding issue in seismo-electric phenomena due to the small signal magnitude, especially the magnetic effect.

The above, and still further objects, features and advantages of certain aspects and embodiments will become apparent upon consideration of the following detailed description of exemplary embodiments, particularly when taken in conjunction with the accompanying drawings, wherein like reference numerals in the various figures are utilized to designate like components.

### BRIEF DESCRIPTION OF THE SEVERAL VIEWS OF THE DRAWINGS

The drawings referenced herein form a part of the specification and are incorporated herein by reference. Features shown in the drawings are meant as illustrative of only some embodiments, and not of all embodiments, unless otherwise explicitly indicated.

FIG. 1 is a representative schematic of groundwater behavior.

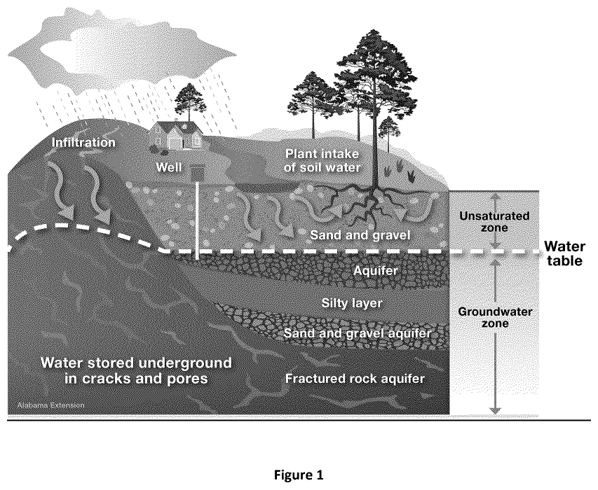

FIG. 2 is a general visualization of an embodiment of the system and its components.

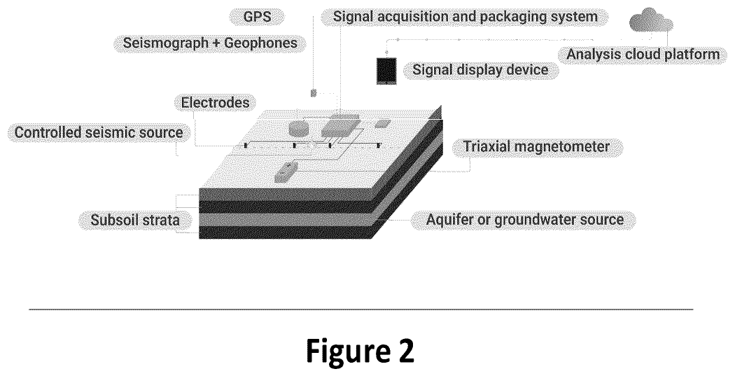

FIG. 3 is a visualization of the physical phenomenon. Depicted on the left is the electrical effect, in the center the seismic effect, and on the right the magnetic effect of a single seismic event.

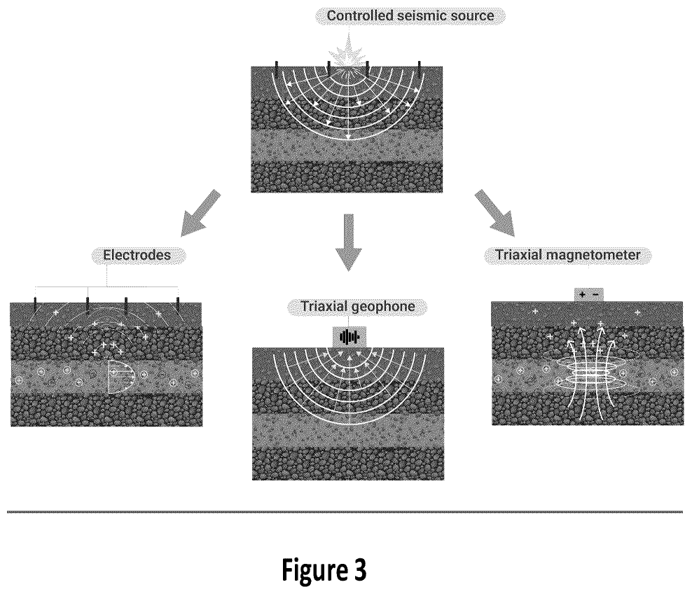

FIG. 4 is a representative diagram of all system components of some embodiments.

FIG. 5 is a representative diagram of the system's field deployment according to an embodiment.

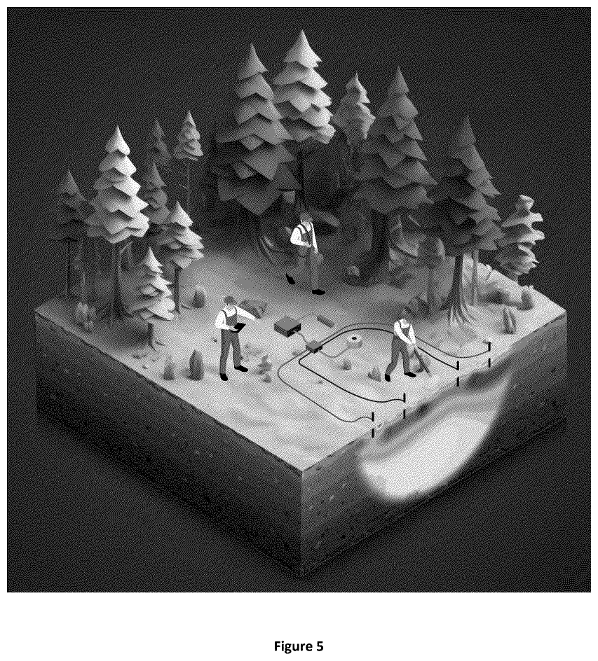

FIGS. 6a, 6b, and 6c are visualizations of signals collected with the system over 60 seconds:

FIG. 7 is a zoomed-in time window of 12 seconds from the first recording shown in the previous figure. The graphs follow the same order.

FIG. 8 includes graphs and charts evidencing a seismo-electric test conducted using the GF-6 system.

### DETAILED DESCRIPTION OF THE EXEMPLARY EMBODIMENTS

It will be readily understood that the components and features of the exemplary embodiments, as generally described herein and illustrated in the Figures, may be arranged and designed in a wide variety of different configurations. Thus, the following detailed description of the embodiments of the methods, devices, assemblies, apparatus, systems, etc. of the exemplary embodiments, as presented in the Figures, is not intended to limit the scope of the embodiments, as claimed, but is merely representative of selected embodiments.

The illustrated embodiments will be best understood by reference to the drawings, wherein like parts are designated by like numerals throughout. Whenever possible, the same reference numbers are used throughout the drawings to refer to the same or like parts. References made to particular examples, details, and representative materials, methods, and implementations are for illustrative purposes only. The following description is intended only by way of example, and illustrates certain selected embodiments of methods, devices, assemblies, apparatus, systems, etc. that are consistent with the embodiments as claimed herein.

The following description with reference to the accompanying figures is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for brevity.

It is to be understood that the singular forms “a,” “an,” and “the” include plural referents unless the context clearly dictates otherwise.

As used herein, the term “and/or” means either or both (or any combination or all of the terms or expressed referred to. For example, “A, B, and/or C” encompasses A alone, B alone, C alone, A and B, A and C, B and C, and A, B, and C).

The terms “have”, “may have”, “can have,” “include”, “may include”, “can include”, “comprise”, and the like used herein indicate the existence of a corresponding feature (e.g., a number, a function, an operation, or an element) and do not exclude the existence of an additional feature.

The terms “first”, “second”, and the like used herein may modify various elements regardless of the order and/or priority thereof, and are used only for distinguishing one element from another element, without limiting the elements, unless the context clearly indicates otherwise. For example, “a first element” and “a second element” may indicate different elements regardless of the order or priority.

It will be understood that when a certain element (e.g., a first element) is referred to as being “operatively or communicatively coupled with/to” or “connected to” another element (e.g., a second element), the certain element may be coupled to the other element directly or via another element (e.g., a third element). However, when a certain element (e.g., a first element) is referred to as being “directly coupled” or “directly connected” to another element (e.g., a second element), there may be no intervening element (e.g., a third element) connecting the element and the other element.

The term “configured (or set) to” as used herein may be interchangeably used with the terms, for example, “suitable for”, “having the capacity to”, “designed to”, “adapted to”, “made to”, or “capable of”. The term “configured (or set) to” may not necessarily have the meaning of “specifically designed to”. In some cases, the term “device configured to” may indicate that the device “may perform” together with other devices or components.

The word “exemplary” is used herein to mean “serving as an example, instance, or illustration.” Any implementation described herein as “exemplary” is not necessarily to be construed as preferred or advantageous over other implementations.

Reference throughout this specification to “a select embodiment,” “one embodiment,” “an exemplary embodiment,” “exemplary embodiments,” “an embodiment,” or “embodiments” means that a particular feature, structure, or characteristic described in connection with the embodiment(s) is included in at least one embodiment. Thus, appearances of the phrases “in a select embodiment,” “in one embodiment,” “in an exemplary embodiment,” “in exemplary embodiments,” “in an embodiment,” or “in embodiments” in various places throughout this specification are not necessarily referring to the same embodiment(s) or only a single embodiment. The embodiments may be, for example, combined with one another in various combinations and modified to include features of one another.

The present disclosure relates to a geophysical system called SEMq, which uses the SER methodology (SeismoElectric and Resistivity) to identify, determine, characterize, and/or quantify groundwater without the need for drilling and with a high degree of precision. The present disclosure further relates to a related process.

In particular, some aspects of the present disclosure refer to a system and a method for the identification, determination, characterization, and/or quantification of groundwater. In some embodiments, the system comprises: (i) an input unit including sensors, modules, and microcontrollers for data capture; (ii) a packaging and information processing unit utilizing software, AI, blockchain, and/or smart contracts; and (iii) an output unit providing data through apps, web platforms, reports, and/or alerts.

Some embodiments of the system for the identification, determination, characterization, and/or quantification of groundwater is characterized by its input unit (i), which includes electric sensors, such as electrodes; magnetic sensors, such as magnetometers; and seismic sensors, such as geophones. In some embodiments, the input unit (i) also integrates atmospheric modules and a global positioning system (GPS or GNSS), which provides the geographic coordinates of the surveyed area. In some embodiments, the system operates in a point-specific manner, meaning that each measurement generates a singular sounding or survey at the investigated location.

### Input Unit

In some embodiments, the system includes an input unit capable of obtaining physical subsurface variables, such as voltage variations in the subsurface, measured with a pair of dipoles. These dipoles comprise, in some embodiments, electrodes that can typically be stainless steel or copper bars between 50 cm and 1 m in length or non-polarizable electrodes constructed with a copper sulfate solution in which a copper bar is immersed. In some embodiments, the container housing the solution has a porous base. Along with voltage measurements, temporal variations in the magnetic field associated with the electric field measured by the electrodes are recorded. This magnetic field variation is captured, for example, by a high-sensitivity magnetometer, which may be, for example, of the Fluxgate or SQUID (Superconducting Quantum Interference Device) type, preferably triaxial, to measure field variations radially.

Additionally, the propagation speed of seismic waves generated by the acoustic stimulus (the precursor to electromagnetic field variations measured by the system) is determined. In some embodiments, these seismic velocities are measured using geophones, which can be triaxial or monoaxial, for example. Concurrently, the global position of the test site may be recorded using, for example, a global positioning system (GPS) (e.g., an integrated GPS). In some embodiments, the surface temperature and humidity at the installation point are measured using, for example, a thermometer and hygrometer, both preferably digital.

In one or more embodiments, each of these sensors is connected to an analog-to-digital converter, which digitizes the analog voltage signals generated by the sensors. In some embodiments, the system includes:
An electric module, measuring voltage variations over time;
A magnetic module, capturing magnetic field variations over time;
A seismic module, allowing for the determination of a simple layer-based seismic model;
An atmospheric module, measuring soil temperature and relative humidity; and
A global positioning module, determining the georeferenced location of the test.

Additionally, in some embodiments, the system connects to a multimedia device, such as a tablet or smartphone, which can take photographs of the site. It should be understood that the present disclosure covers input units comprising fewer than all of the above-discussed components, and/or input units comprising additional components not discussed herein.

### Packaging and Information Processing Unit

In some embodiments, the packaging and information processing unit (ii) is characterized by its microcontroller, which packages the data collected from the sensors of the input unit. The packaged data undergoes processing through signal standardization software before being analyzed by specific software, AI algorithms, blockchain, and/or smart contracts. This process generates geophysical and hydrogeological models.

According to some embodiments, in this unit, all information gathered by each module is packaged by a microprocessor controlled by the microcontroller, which manages the timing and sampling rate of the system. Additionally, in some embodiments the system allows for manual activation to initiate data recording or uses a trigger—a switch-based mechanism that starts recording when the acoustic stimulus is generated. In some embodiments, the trigger is synchronized with the stimulus, enabling the system to identify the controlled seismic event caused by the acoustic trigger.

### Output Unit

Finally, in some embodiments the output unit (iii) provides information through reports and alerts, for example via apps or web platforms, regarding the presence or absence of groundwater in surveyed areas. In cases where groundwater is detected, the system determines characteristics of the subsurface water sources, for example, the depth of subsurface water sources, such as aquifers and water table levels. In some embodiments the output unit (iii) also estimates flow rates and creates a stratigraphy of the surveyed area. In some embodiments, the collected data feeds into a predictive model and hydrological analysis system, which can be used to develop hydrogeological and hydrological insights for water security planning.

In some embodiments, once acquired, data is stored in an internal storage device, such as, for example, a hard drive or SD card, before being sent to, for example, a server or cloud for storage and processing. The system can independently perform basic signal processing, enabling the visualization of sensor data and geographic coordinates. For advanced processing according to some embodiments, the data is transmitted to a platform equipped with robust algorithms to process each signal, delivering geophysical and hydrogeological models as the final result.

### Example of Implementation

To address the problem of identifying, determining, characterizing, and quantifying groundwater, an innovative technology has been developed to improve global water management and ensure its availability. As mentioned, this technology is based on a geophysical system called SEMq, which in some embodiments utilizes the SER (SeismoElectric and Resistivity) methodology to detect and quantify groundwater without the need for drilling. In some embodiments, this technology includes specific hardware capable of measuring electrical, magnetic, and seismic parameters through the implementation of electrodes, magnetometers, and geophones. For example, regarding magnetic parameters, this innovative and cutting-edge technology can integrate sensors capable of measuring extremely small variations in the magnetic field, such as quantum sensors of the SQUID type, which allow measuring magnetic field variations at the femto-Tesla level (10⁻¹⁵ T), or Fluxgate sensors, which can measure variations of 1 Nano-Tesla (10⁻⁹ T), making it the only geophysical system of its kind so far.

In some exemplary embodiments, the developed system provides precise and reliable information, which is integrated with a Web3 platform that enables storing the collected data using blockchain technology, such as NFTs (Non-Fungible Tokens). In some embodiments, the system leverages the results of geophysical data analysis to create hydrological models, which are used to estimate groundwater flow and transport within an aquifer. This allows for determining potentially productive locations for exploiting existing groundwater resources that can serve human activities such as agriculture, industry, and/or communities in need of durable and clean water supply.

Accordingly, in exemplary embodiments an innovative geophysical system based on the seismo-electromagnetic (SEM) effect has been developed, enhanced with Web3 technology and NFTs for storing and protecting collected information. Exemplary embodiments of the system allow the detection of groundwater from the surface to hundreds of meters in depth, pinpointing the precise location of the groundwater in the subsurface by characterizing the hydrogeological parameters of aquifers and estimating a possible extraction flow rate of the identified water sources without the need to drill. This is achieved using a combination of state-of-the-art hardware and advanced technology, such as artificial intelligence and/or blockchain, enabling the creation of precise and high-quality hydrogeological models for decision-making.

The initially conceived SEMq prototype measured the electrical component, which already made it possible to detect water. This initial prototype was later enhanced by incorporating two new parameters: magnetic fields and seismic wave velocities, through two additional sensors. These additions reduce uncertainty and increase precision.

Accordingly, in exemplary embodiments the SEMq system (hardware) has been designed and built using cutting-edge technology, including high-precision magnetic sensors such as Fluxgate Magnetometers or SQUIDs (Superconducting Quantum Interference Devices). These significantly improve magnetic field measurements, aiming to reduce uncertainty and enhance groundwater detection accuracy.

This developed system, including hardware, has been technically validated through field measurements and comparisons with known information to ensure its effectiveness in groundwater detection. Specifically, the system has been able to describe and characterize the subsurface through stratigraphy and identification of water levels in the subsurface. Subsequently, wells have been drilled, with physical evidence aligning with the stratigraphy predicted by the system in most cases. Additionally, the system has successfully predicted the extraction flow rate of these wells, although this has proven more variable, as the flow rate depends on the type of well constructed and the drilling methodology used.

This development is complemented by creating an online platform to integrate the data obtained by the SEMq system. The platform enables automated analysis using artificial intelligence to improve decision-making efficiency and data interpretation. This is achieved as the data collected by the system is uploaded to a platform featuring a physical-mathematical algorithm that analyzes the signals from each sensor (electrical, magnetic, and seismic). Once processed, the data, based on time series, is compared to thousands of other signals known to the trained AI system. This allows distinguishing when a signal meets quality standards and comparing the signal with other signals from known geological contexts, such as distances to known water sources, such as the hydrographic network or wells stored in the database. This enables more accurate and refined interpretation. Once this is completed, the platform integrates this geophysical information into a multivariable system that enables the creation of hydrogeological models with unprecedented precision.

Specifically, the developed technology integrates hardware that identifies groundwater based on two different physical phenomena the technology generates in the subsurface. The first is the seismo-electric phenomenon, which involves measuring the electrical response generated in water when an acoustic stimulus is applied to it. This helps determine the permeability or hydraulic conductivity of the material. The second is the effect water has on its surroundings, modifying the electrical resistivity of the interacting material (electrical resistivity refers to a material's ability to oppose electric current flow, measured in Ohm-m). This is achieved by measuring variations in the electrical and magnetic fields produced by the electrical response to the seismic or acoustic stimulus.

Thus, exemplary embodiments of this system become the only one capable of simultaneously measuring three physical parameters—electrical, magnetic, and seismic—from a single event. The combination of both methods, SeismoElectric and Resistivity, henceforth referred to as SER, within a single geophysical system, does not exist in the current state of the art. However, there is demonstrable evidence of the effectiveness of combining these two methods, as numerous geophysical studies have been conducted using independent systems measuring these parameters. Following these studies, one or more wells have been drilled, yielding successful results.

A specific study, which took approximately four years to complete, involved about 5,000 SER surveys. From these, 500 potential sites for drilling wells were identified, and approximately 120 wells were ultimately drilled. An error rate of 20% in data accuracy was determined. This outcome identified certain shortcomings that the SEMq system aims to address to improve uncertainty levels. These shortcomings are mitigated by integrating a seismic system capable of estimating in situ the layered seismic model of the surveyed site and measuring the residual magnetic field of the electric field recorded by existing seismo-electric systems on the market. This enhancement enables the measurement and observation of the modulation of electrical resistivity, for which evidence suggests it will improve the flow rate estimation provided by the current system (GF-6).

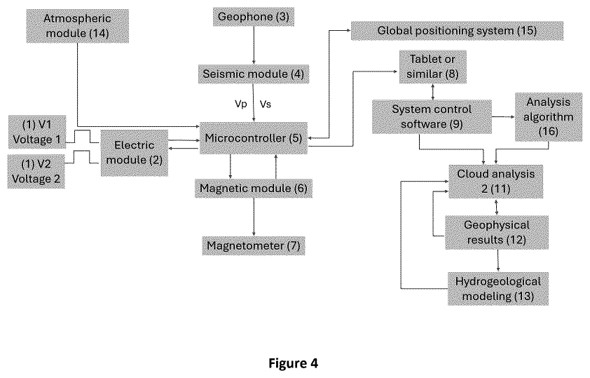

Referring now to FIG. 4, a system according to an exemplary embodiment is shown including (reference numerals correspond to those of FIG. 4): (1) two dipoles or pairs of electrodes for measuring surface voltage variation due to the controlled seismic event (seismo-electric effect); (2) analog-to-digital converter for the electric signals (voltage from dipoles); (3) seismic sensor (geophone) for measuring the seismic event; (4) analog-to-digital converter for the seismic signal; (5) microcontroller for integrating data packets for each module and sensor; (6) analog-to-digital converter for the magnetic signal; (7) electronic control unit, such as a tablet, personal computer (PC), or similar device or system, preferably with data storage capability; (9) system control software and signal visualizer (10) quality control software; (11) cloud-based data analysis software and result visualization; (12) geophysical models and data inversion; (13) integration of geophysical results with GIS information; (14) soil temperature and humidity sensor; and (15) integrated global positioning system (GPS or GNSS).

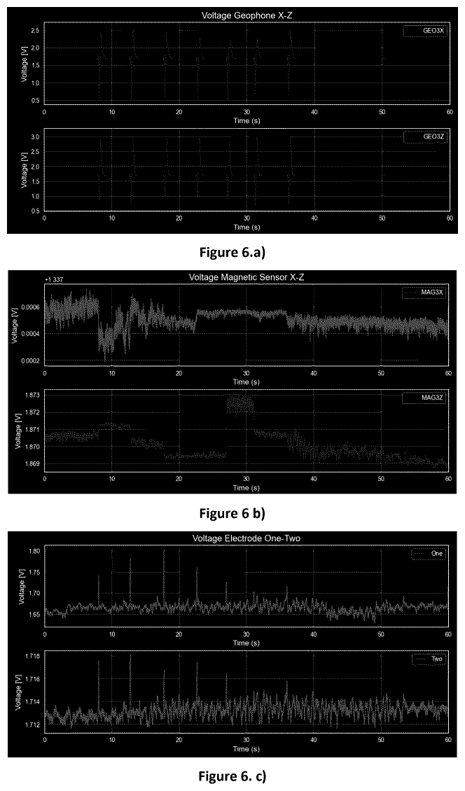

FIG. 6 illustrates an embodiment of a visualization of signals collected over 60 seconds. FIG. 6(a) shows seismic signals recorded by a triaxial geophone on the X and Z channels, with FIG. 6(a) showing seven seismic events generated by hitting the ground with a sledgehammer. FIG. 6(b) shows magnetic signals recorded by a triaxial magnetometer on the X and Z channels for the same seven events. FIG. 6(c) shows electrical signal recorded by the dipoles for the seven events.

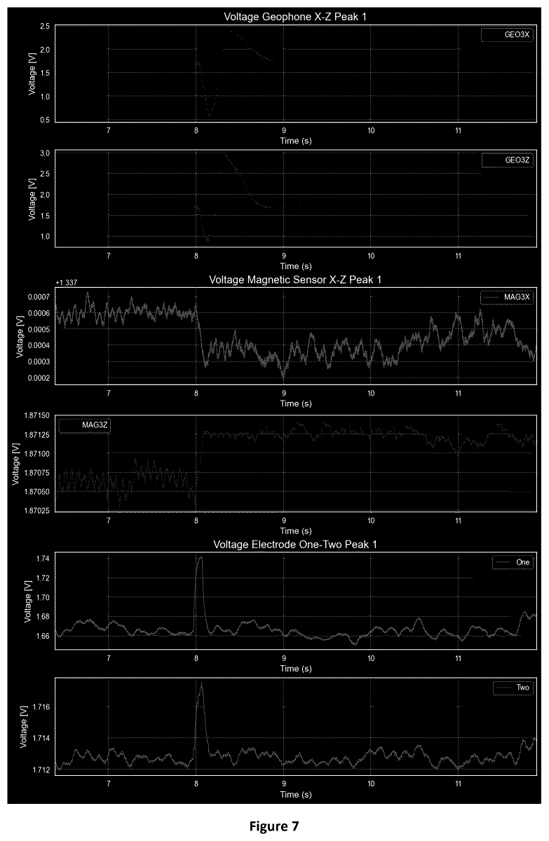

FIG. 7 illustrates a recording of second 6 through 12 of the 60-second recording of FIG. 6. FIG. 7 shows the system operating with seismic sensors (triaxial geophones), magnetic sensors (triaxial magnetometers), and electrodes. Seven controlled seismic events were generated by hitting the ground with a sledgehammer at regular time intervals, allowing observation of the event's record across all system modules. For both the seismic and magnetic modules, the X and Z components were analyzed as they are the most relevant for characterizing the seismo-electromagnetic phenomenon. Each impact shows responses from all sensors, demonstrating the presence of the seismo-electromagnetic phenomenon in all its components. A zoomed-in view isolates the first impact, showing the seismic record detected simultaneously by the geophone in both channels, indicating proper sensor and system electronics functionality. The same applies to the magnetic and electrical modules, demonstrating the expected phenomenon: magnetic field variations in response to the electrical field generated by the seismo-electric phenomenon during the impact. This is most clearly observed in the zoomed-in section at 8 seconds.

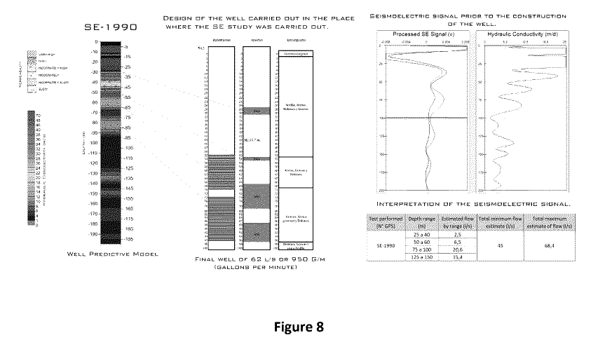

FIG. 8 includes graphs and charts evidencing a seismo-electric test conducted using the GF-6 system. On the right side, the electrical record of a test is displayed, with an interpretation described herein. On the left side, a 1D model shows the distribution of hydraulic conductivity derived from the electrical signal on the right, highlighting areas contributing to groundwater. In the center, the final design of a well drilled at the test location is shown. Red lines correlate groundwater contributions predicted with the actual results. A correlation of approximately 85% is observed between the prediction and the final outcome.

### Example of Implementation

To address the technical challenge of data interpretation, an algorithm has been developed based on artificial intelligence and machine learning tools (explain/provide examples). An exemplary embodiment of the algorithm will now be described. This algorithm interprets data acquired by geophysical equipment. The algorithm collects all the electrical, magnetic, and seismic data from the surveyed site. The algorithm then determines the global position of the survey. Subsequently, the algorithm compares the acquired signals with previously known and verified signals from the database. Additionally, the algorithm compares the results with information from nearby wells stored in the database.

Furthermore, the algorithm identifies the altitude of the survey point, reviewing the hydrographic network near the survey site to determine the distances from the surveyed point to any streams or rivers that may contribute groundwater to the area. Finally, the algorithm analyzes the climatic conditions of the region using satellite images to calculate hydrological and hydrogeological parameters for the area. By conducting a cross-correlation of all this information, the algorithm delivers results consistent with the physical data collected.

Currently, studies have been conducted using two distinct systems: the GF-6 seismo-electric system by Aqualocate and the EH-4 audio magnetotelluric system by Geometrics Inc. These systems work simultaneously but are not interconnected, resulting in a labor-intensive process. However, with the implementation of the SER system, this bottleneck can be resolved, increasing efficiency in problem-solving and accelerating the replication of the model/solution.

Based on this, the SEMq system of an exemplary embodiment includes the following components:
Main Unit (Microcontroller): Responsible for packaging the information collected from each physical sensor in the geophysical instrument. The sensors include:
Electrodes: Measure the electrical potential difference generated by the acoustic stimulus on the surface caused by a controlled seismic source. These are typically metal bars or non-polarizable electrodes.
Magnetometer: Measures the magnetic field variation induced by the acoustic stimulus on water molecules in the subsurface.
Geophone: Detects vibrations in the subsurface caused by the controlled seismic source on the surface.
Trigger or Triggering Device: An electronic device that starts recording the seismo-electromagnetic data when the seismic source is triggered on the surface.
Soil Temperature Sensor: Measures the relative temperature of the soil during the seismo-electromagnetic measurement.
Soil Moisture Sensor: Measures the relative humidity of the soil during the seismo-electromagnetic measurement.
Global Positioning System (GPS): Georeferences the measurement point in real-time, keeping a record of the geographic location each time a measurement is performed.

Each of these sensors is connected via cables, which must have a shielding system to prevent any external interference with the physical phenomenon being measured.

All the aforementioned sensors have their integrated modules or circuits, which are connected to the microcontroller.

In addition to the sensors, there is the triggering device, which generates the seismic stimulus necessary for characterizing the seismo-electromagnetic phenomenon. This triggering system can involve striking a sledgehammer against a plate placed on the ground, detonating a controlled explosive charge, using a hydraulic system capable of delivering a controlled strike to the ground, or generating an acoustic stimulus with a low-frequency acoustic wave generator, such as a speaker or a similar device.

Continuing with the description, the microcontroller, besides packaging all the previously mentioned information, is also responsible for transferring the data via Bluetooth to a smart device such as a tablet, notebook, or similar, allowing the data to be visualized on this device.

In exemplary embodiments, the device receiving the information is capable of performing initial data processing, enabling the operator to make a quality control decision regarding the signals captured by the SEMq system. Once this information is approved, it is stored both on the receiving device and within the SEMq system using an SD card. Additionally, the option exists to send this information to a cloud-based platform where the data can be processed further, both at the initial level and at a more advanced level, allowing for the extraction of hydrogeological parameters.

Below is a descriptive table of the system components used as part of this implementation example. However, these specifications do not limit the scope of the disclosure, as they refer to general component specifications.

| Component | Selected alternatives | Function |
|---|---|---|
| Microcontroller | ESP32-WROOM-32UE-N16 | Processor that manages the general |
| | | operation of the system, responsible for |
| | | receiving commands by BT, synchronizing |
| | | signal measurement and storing them in a |
| | | microSD memory. |
| Triaxial | There are several | Seismic signal measurement. |
| Geophone | alternatives on the market. | |
| Triaxial | Fluxgate Magnetometer | Measurement of low-frequency magnetic |
| magnetometer | Model FGM3D or SQUID | signals |
| | Sensor | |
| Bluetooth | ESP32-WROOM-32UE-N16 | Transfer of commands and data between |
| connection | (BT-serial) | the measuring device and an Android |
| | | mobile app |
| USB-C connector | USB-C | Connection through which the batteries |
| | | of the equipment are charged and the |
| | | firmware of the microcontroller is |
| | | updated |
| USB-Serial | CP2102N-A02-GQFN24 | Integrated for communication |
| | | management between the computer and |
| | | the microcontroller, through which |
| | | firmware can be updated and data |
| | | transmitted |
| Demultiplexer | 2 × 74HC138BQ, 115 | It is used to select the different ADCs, |
| | | allowing communication with each one |
| | | independently. |
| IOExpander | PCA9535PW, 118 | Allows you to expand the number of |
| | | inputs/outputs through an 12C port, |
| | | through which the status of the power |
| | | LED is controlled, the battery charge |
| | | status is received, and the interrupt |
| | | signals from the ADC converters are |
| | | received |
| Battery charger | 5 V battery charger based | It supplies electrical current to the battery |
| | on BQ24259RGER | so that it recovers its energy charge. |
| Lithium battery | Pack of 2 Li-ion batteries, | It stores energy. |
| | each 3400 mAh and 3.7 V | |
| Main Power | From batteries generates | It delivers power primarily to the |
| Source | 3.3 V | microcontroller and ADCs, microSDs, as |
| | | well as minor integrated circuits such as |
| | | amplifiers, operations, and demultiplexers |
| Secondary Power | Unit generating 18 V | It delivers power to the magnetometer |
| Sources(1) | and ± 14 V | and op-amps, using the 18 V source as a |
| | | base, from which +−14 V is produced |
| Secondary Power | Unit Generating 10 V | Delivers power to the temperature and |
| Sources(2) | | humidity sensor |
| 2-color LED | 2-color LED | Allows you to indicate the different |
| | | operating statuses of the equipment |
| LED button | Latch button with an LED | It allows you to turn on the equipment |
| | | and through the LED indicate if it is on or |
| | | off. |
| Reference voltage | REF3033 | Reference voltage, used by ADCs, allowing |
| | | consistent and stable digitization of |
| | | signals. |
| ADC | MCP3561RT-E/NC | Responsible for converting analog signals |
| | | into digital ones, which come from the |
| | | following sensors: Geophone, |
| | | magnetometer, seismoelectric stakes, |
| | | temperature and humidity |
| Op-Amp | AD8605, LMV321 & | It allows the adaptation of analog signals |
| | OPA2376AIDR | so that they can then be read by ADCs |
| 16 MHz Oscillator | 1532H4-16000JWPDTSNL | Integrated responsible for generating the |
| | | clock signal to different ADCs |
| USB-C connector | USB-C | Connection through which the batteries |
| | | of the equipment are charged and the |
| | | firmware of the microcontroller is |
| | | updated |
| 4-pin connector | 1 × 2B FGG EGG, 4 Pin | Connection for humidity and temperature |
| | | sensor |
| 3-pin connector | 1 × 2B FGG EGG, 3 Pin | Connection for trigger signal |
| 12-pin connector | 1 × 3B FGG EGG, 12 Pin | Magnetometer signal connection |
| 7-pin connector | 1 × 3B, FGG EGG, 7 Pin | 3-axis geophone connection |
| 2-pin connector | 4 × 2B, FGG EGG, 2 Pin | Connection for electrodes |
| Global positioning | Dual mode GNSS module | Take the coordinate and elevation of the |
| | UART GPS GALILEO | prospected place for georeferencing. |
| | GLONASS, 3.3-5 V, | |
| | integrated FLASH receiver, | |
| | NMEA0183, TOPGNSS. | |
| Temperature and | NPK 4-20 ma 0-5 V Modbus | It allows measuring the temperature and |
| humidity sensor | RS485 | humidity of the soil where the system is |
| | | installed. |

It will be understood by those with skill in the art that if a specific number of an introduced claim element is intended, such intent will be explicitly recited in the claims, and in the absence of such recitation no such limitation is present. For a non-limiting example, as an aid to understanding, the appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles.

While particular embodiments have been shown and described, it will be understood to those skilled in the art that based upon the teachings herein, changes and modifications may be made without departing from its broader aspects. Therefore, the appended claims are to encompass within their scope all such changes and modifications as are within the true spirit and scope of the embodiments.

What is claimed is:

1. A system for identification, determination, characterization, and/or quantification of groundwater, the system comprising:
an information input unit comprising sensors, modules, and microcontrollers configured for data acquisition relating to the groundwater at a prospecting site;
an information packaging and processing unit configured to utilize software, artificial intelligence (AI), blockchain, and/or smart contracts configured to identify, determine, characterize, and/or quantify the groundwater; and
an information output unit configured to output information relating to the identification, determination, characterization, and/or quantification of the groundwater through applications, web platforms, reports, and/or alerts.

2. The system according to claim 1, wherein:
the sensors of the information input unit comprise electrical sensors, magnetic sensors, and seismic sensors; and
the modules of the information input unit comprise one or more atmospheric modules and one or more global positioning module, the one or more global positioning module comprising a global positioning system (GPS), a global navigation satellite system (GNSS), or GPS and GNSS, the global positioning module being configured to obtain geographic coordinates of the location of the prospecting site.

3. The system according to claim 2, wherein the electrical sensors comprise electrodes, wherein the magnetic sensors comprise magnetometers, and wherein the seismic sensors comprise geophones.

4. The system according to claim 3, wherein the system is configured to operate on a point-based mode, wherein each measurement generates a specific survey or sounding of the prospected site.

5. The system according to claim 1, wherein the information packaging and processing unit comprises a microcontroller configured to process data received from the information input unit for each sensor.

6. The system according to claim 5, wherein the information packaging and processing unit is configured to utilize the data through a signal standardization software, enabling subsequent processing by specialized software, AI, Blockchain, and/or smart contracts, which are configured generate geophysical and hydrogeological models.

7. The system according to claim 1, wherein the information output unit is configured to deliver the reports and the alerts via applications or the web platforms.

8. The system according to claim 7, wherein the information output unit is configured to provide information about the presence or absence of groundwater in the prospecting site.

9. The system according to claim 8, wherein the information output unit is further configured to provide depth and water table levels, estimate flow rates, and provide a stratigraphy of the prospecting site.

10. The system according to claim 9, wherein the information output unit is further configured to collect data and feed the collected data into a predictive and hydrological analysis model, wherein the predictive and hydrological analysis model is configured to analyze hydrogeological and hydrological information to create a water security plan.

11. A process for identification, determination, characterization, and/or quantification of groundwater, the system comprising:
providing sensors, modules, and microcontrollers configured for data acquisition relating to the groundwater at a prospecting site;
utilizing software, artificial intelligence (AI), blockchain, and/or smart contracts to identify, determine, characterize, and/or quantify the groundwater; and
outputting information relating to the identification, determination, characterization, and/or quantification of the groundwater through applications, web platforms, reports, and/or alerts.

12. The process according to claim 11, wherein:
the sensors comprise electrical sensors, magnetic sensors, and seismic sensors; and
the modules comprise one or more atmospheric modules and one or more global positioning module, the one or more global positioning module comprising a global positioning system (GPS), a global navigation satellite system (GNSS), or GPS and GNSS, the global positioning module being configured to obtain geographic coordinates of the location of the prospecting site.

13. The process according to claim 12, wherein the electrical sensors comprise electrodes, wherein the magnetic sensors comprise magnetometers, and wherein the seismic sensors comprise geophones.

14. The process according to claim 13, wherein the process operates on a point-based mode, wherein each measurement generates a specific survey or sounding of the prospected site.

15. The process according to claim 11, wherein utilizing software, AI, blockchain, and/or smart contracts comprises utilizing a microcontroller to process data received from the information input unit for each sensor.

16. The process according to claim 15, wherein the utilizing software, AI blockchain, and/or smart contracts comprises utilizing the data through a signal standardization software, and subsequently processing the data utilizing specialized software, AI, Blockchain, and/or smart contracts, which are configured generate geophysical and hydrogeological models.

17. The process according to claim 11, wherein the outputting comprises delivering the reports and the alerts via applications or the web platforms.

18. The process according to claim 17, wherein the outputting comprises providing information about the presence or absence of groundwater in the prospecting site.

19. The process according to claim 18, wherein the outputting comprises providing depth and water table levels, estimate flow rates, and provide a stratigraphy of the prospecting site.

20. The process according to claim 19, further comprising collecting data and feeding the collected data into a predictive and hydrological analysis model, wherein the predictive and hydrological analysis model is configured to analyze hydrogeological and hydrological information to create a water security plan.
